(19) United States
(12) Patent Application Publication
(10) Pub. No.: US 2026/0369940 A1
(43) Pub. Date: Nov. 19, 2026

(54) PLUG CONNECTOR AND METHOD FOR ASSEMBLING A PLUG CONNECTOR

(71) Applicant: Rosenberger Hochfrequenztechnik GmbH & Co. KG, Fridolfing (DE)

(72) Inventor: Manuel PEMWIESER, Fridolfing (DE)

(21) Appl. No.: 19/448,668

(22) Filed: Jan. 14, 2026

(30) Foreign Application Priority Data
Jan. 23, 2025 (EP) 25 153 506.8

(51) Int. Cl. H01R 24/40; H01R 43/20; H01R 103/00

(52) U.S. Cl. CPC H01R 24/40; H01R 43/20; H01R 2103/00

(57) ABSTRACT

A plug connector, in particular an electrical plug connector, having a first component and a second component directly fastened to the first component, wherein the first component has a locking unit that can be temporarily deflected elastically from a mechanically relaxed initial state to an intermediate state via a flexure hinge. The locking unit has a locking means that can be locked to the second component for mutual fastening of the two components. It is provided that the flexure hinge is torsionable and is formed by two opposing side arms extending at an angle to a longitudinal axis of the locking unit.

### CROSS-REFERENCE TO RELATED APPLICATION

This application claims the benefit and priority of European Patent App. Ser. No. 25 153 506.8 filed on Jan. 23, 2025, the entire disclosure of which is incorporated herein by reference.

### FIELD OF THE INVENTION

The invention relates to a plug connector, in particular an electrical plug connector, having a first component and a second component directly fastened to the first component, wherein the first component has a locking unit that can be temporarily deflected elastically from a mechanically relaxed initial state to an intermediate state via a flexure hinge, according to the preamble of claim 1.

The invention further relates to a method for assembling a plug connector.

### BACKGROUND OF THE INVENTION

Various electrical and optical plug connectors are known from electrical and communications engineering. Plug connectors are known to transmit electrical power and/or electrical or optical data signals to corresponding mating plug connectors. A plug connector or mating plug connector can be, among other things, a plug, a board connector, a panel connector, a socket, a coupler, or an adapter. The terms “plug connector” and “mating plug connector” used within the scope of the invention are representative of all variants.

During the manufacture or assembly of a plug connector, various components typically need to be fastened to one another. For example, contact elements of the plug connector often need to be assembled within a suitable, electrically insulating contact element carrier (e.g. an electrically insulating outer housing or a dielectric/insulating element). In practice, locking tabs are sometimes used to fix the contact elements. U.S. Pat. No. 6,361,379 B1 serves at this point as an example of such a mechanical locking connection.

Particularly high demands are placed on the robustness and safety of plug connectors for the automotive industry and vehicles. For example, in conjunction with sensors (e.g. cameras) and actuators for driver assistance systems, safety aspects of the plug connectors involved are paramount. Electromobility, in particular, presents the automotive industry and its suppliers with significant challenges, as high currents and voltages of up to 1,500 V are sometimes transmitted via the cables and wires in the vehicles. A plug connection in a vehicle must withstand potentially high loads, such as mechanical stress, and remain reliably closed so that the electrical connection is not unintentionally interrupted, for example, during vehicle operation.

To increase the holding force of a locking tab in the corresponding locking recess, securing means are typically used that mechanically block the locking tab from springing out of the locking recess (also known as “Primary Locking Reinforcement”, “PLR”) and/or so-called secondary securing elements are used, i.e. in particular redundant locking connections that additionally secure the mutual fixing of the components.

Especially when the installation space within the plug connector is limited, providing the aforementioned securing means or secondary securing elements is sometimes not easily possible. A further problem with limited installation space can be that the locking tab can then only be relatively short and has a correspondingly rigid geometry. This adversely increases the assembly force and, in the worst case, can lead to abrasion of the locking hook during the assembly process, which can mechanically impair it.

Furthermore, the known measures for securing locking tabs are generally comparatively complex, which contradicts the principle of economical manufacturing of plug connectors.

### SUMMARY OF THE INVENTION

In view of the known prior art, the object of the present invention is to provide a mechanically robust plug connector suitable for preferably high safety requirements, which can be manufactured economically in mass production and which preferably has a compact design.

The object on which the present invention is based is also to provide a method for assembling a mechanically robust plug connector, preferably suitable for high safety requirements and preferably having a compact design, which is particularly economically applicable in the context of mass production.

The object is achieved for the plug connector with the features listed in claim 1. With regard to the method, the object is achieved by the features of claim 14.

The dependent claims and the features described below relate to advantageous embodiments and variants of the invention.

The invention relates to a plug connector, having a first component and a second component directly fastened to the first component.

The plug connector can be, in particular, an electrical or optical plug connector. The invention is described below essentially on the basis of an electrical plug connector, but this is not to be understood as limiting the invention.

The electrical plug connector can be formed in virtually any way. For example, the electrical plug connector can be a data plug connector, in particular a high-frequency plug connector, or a plug connector for transmitting electrical power, such as, for example, automotive high-voltage plug connectors. The electrical plug connector can in principle have any desired number of contact elements, for example, one or more inner conductor contact elements and one outer conductor contact element. The plug connector can be formed as a linear or straight plug connector or angled plug connector. In principle, any desired variants of plug connector are possible.

According to the invention, the first component has a locking unit that can be temporarily deflected elastically from a mechanically relaxed initial state to an intermediate state. The locking unit has a locking means that can be locked with the second component for mutual fastening of the two components. The deflection of the locking unit is effected via a flexure hinge.

A flexure hinge is understood to be a mechanical structure that derives its mobility from the elastic deformation of a continuous, solid body, rather than from separate, moving parts, as in conventional hinges or joints. Preferably, the flexure hinge according to the present invention is formed monolithically from the first component.

The elastic deflection into the intermediate state preferably occurs non-destructively or reversibly, in contrast to plastic deformation.

According to the invention, the flexure hinge is designed to be torsionable and formed by two opposing side arms extending at an angle to a longitudinal axis direction of the locking unit.

In the present case, a torsionable flexure hinge is understood to be, in particular, a flexure hinge that allows the elastic deflection of the flexure hinge from its initial state to an intermediate state by means of torsion or twisting of the material of the first component, especially the aforementioned side arms. This is not intended to preclude the possibility that deformation due to bending may also occur. A combined mechanical stress of bending and torsion can therefore also be provided. Preferably, however, torsion dominates within the scope of the aforementioned elastic deflection.

By using the torsionable flexure hinge, or rather its two opposing side arms, this design can be implemented within the plug connector while requiring minimal space. It has been shown that a torsionally based flexure hinge allows for relatively low-force tilting of the locking unit, despite its rigid geometry. The proposed flexure hinge can therefore be advantageously implemented even in the case of a particularly compact plug connector design and also offers the advantage of a gentle and convenient assembly process.

The flexure hinge can advantageously form a movable mechanical connection between the locking unit and the remaining body of the first component (hereinafter referred to as the “residual body”). The locking unit can preferably be formed integrally with the residual body. The residual body, or at least a section or part of it, can preferably be formed at least substantially in the shape of a sleeve.

The locking unit can, in particular, be formed in the manner of a snap-fit rocker.

It should be mentioned at this point that the locking unit is preferably an at least substantially rigid component (or is formed of at least substantially rigid material), but the locking unit can still be formed in such a way that at least a slight degree of flexibility or elastic deformability is possible, which is required during the assembly of the second component.

Preferably, the locking unit or the first component is made of a plastic, in particular a thermoplastic or thermoset, but preferably not an elastomer.

In one advantageous development of the invention, it can be provided that the second component is at least partially received within the first component or the first component is at least partially received within the second component.

Preferably, the second component is at least partially or sectionally received within the first component, i.e. the first component, which has the locking unit, surrounds the second component at least partially or in sections.

Alternatively, the second component can also at least partially or sectionally surround or enclose the first component. It should be emphasized here that the features and advantages of the first component mentioned above and below can also be transferred to the second component- and vice versa. Consequently, it is even possible for both components to each have a locking unit with a locking means.

The first component and/or the second component can be formed, at least in sections, to be essentially hollow cylindrical or sleeve-shaped (e.g. with a round, oval, rectangular, or other polygonal cross-section). In particular, it can be provided that at least the section of the first component in which the locking unit is arranged (and thus, if applicable, also the recess for the locking unit mentioned below) is formed to be hollow cylindrical or sleeve-shaped. The residual body of the first component can, in principle, have any desired structure and does not necessarily have to have a hollow cylindrical or sleeve-shaped structure.

According to one development of the invention, it can be provided that the side arms extend at least substantially orthogonally to the longitudinal axis direction of the locking unit

While a profile of the side arms orthogonal to the longitudinal axis of the locking unit is preferred, it is not strictly necessary for the realization of the invention. In a less preferred configuration of the invention, for example, it can in principle also be provided that the side arms run tilted relative to the longitudinal axis direction of the locking unit by a tilting angle of 45°, preferably by at least 60°, and even more preferably by at least 85°, 86°, 87°, 88°or 89°.

The side arms are preferably aligned with each other, i.e. arranged at least substantially at the same axial position along the longitudinal axis of the locking unit on opposite sides or sides facing away from one another of the locking unit. However, due to tolerances, the side arms may also be slightly offset axially from each other.

In one configuration of the invention, it can be provided that the cross-section of the first component is at least substantially closed circumferentially in the region of the axial position of the side arms. Conversely, it can be provided that the cross-section of the first component is interrupted circumferentially at the axial positions adjacent to the side arms, particularly at axial positions directly bordering the side arms.

According to one development of the invention, it can be provided that the first component, in particular the residual body of the first component, has a recess in which the locking unit is movably arranged, in particular tiltable in the direction of the second component. The locking unit may, in particular, be connected to the residual body of the first component via the side arms and be fastened within the recess.

The residual body (or at least the part of the residual body in which the recess for the locking unit is formed) can preferably be formed at least substantially in the shape of a sleeve.

The recess in the first component can preferably run at least partially along the longitudinal axis direction of the locking unit. For example, the section of the first component having the locking unit can be laterally cut open (except for the areas where the side arms are arranged). The first component can, for example, have a C-shaped cross-section at least partially along its longitudinal extent.

Preferably, the longitudinal extent of the recess is greater than the longitudinal extent of the locking unit. Preferably, the transverse extent of the recess is also greater than the transverse extent of the locking unit, in particular by the sum of the longitudinal extents of the two side arms of the flexure hinge greater than the transverse extent of the locking unit.

The elastic deflection of the locking unit, or the rocking or pivoting movement of the locking unit when deflected from the initial state, can run in the direction of or away from the central axis of the first component.

In one development of the invention, it can be provided that the locking unit has two opposing, freely movable axial ends along the longitudinal axis direction.

In particular, it can be provided that the side arms of the locking unit are formed in an axial central section along the longitudinal axis direction, preferably centrally between the axial ends of the locking unit.

Although the side arms are preferably arranged in a central axial section along the longitudinal axis of the locking unit, they can also be arranged at an axial end section or end of the locking unit (less preferred, as the securing function of the locking unit can be ensured by the assembled second component) or at least eccentrically offset. The position of the side arms can be determined by the person skilled in the art depending on the application, including for the defined setting of the required (maximum) assembly force. It may even be possible for the side arms to be arranged at one of the axial ends of the first component.

In one development of the invention, it can be provided that the locking unit is inaccessible from outside the plug connector.

In particular, it can be provided that the locking unit is not one that can be manually or directly operated by a fitter. The locking unit may therefore even be inaccessible to mechanical operation by a fitter.

However, it is in principle not strictly necessary for the locking unit to be inaccessible to the fitter. Generally, manual operation of the locking unit by the fitter is at least not intended, which is why it can be advantageous to provide additional protection for the locking unit, for example, by surrounding it with a surrounding structure of the first component or another, separate component.

In one particularly preferred development of the invention, it can be provided that the second component can be assembled in the direction of a plug-side end or plug-in interface of the plug connector, wherein the locking unit can be directly mechanically contacted by the second component during its assembly and deflected from the initial state to the intermediate state. The part or section of the second component suitable for this purpose can, for example, be a plug-side end section that leads in one assembly direction, a plug-side end of the second component, a diameter step set back from the plug-side end section of the second component, or a lateral-side projection/elevation.

This makes assembling the plug connector particularly convenient and straightforward for a fitter, as the locking unit engages automatically when the second component is installed. This also helps avoid assembly errors and reduces assembly time.

Preferably, a leading edge or end face of the second component, or the aforementioned diameter step/lateral-side projection, can interact with a corresponding contact surface of the locking unit of the first component to mechanically deflect the locking unit around the flexure hinge. Optionally, the locking unit or its contact surface and/or the leading, plug-side end of the second component can be inclined relative to the assembly direction so that the assembly movement can be translated into the deflection movement of the locking unit as gently as possible. A slanted surface of the locking element or the end face of the locking unit (e.g. a chamfer or rounded edge) is particularly suitable for this purpose.

In one development of the invention, it can be provided that the side arms of the locking unit are located in an axial position between a plug-side end section and a cable-side end section of the second component facing away from the plug-side end section when the second component is fully assembled.

The plug-side end section or the plug-side end of the second component is therefore preferably positioned closer to the plug-side end of the connector than the flexure hinge or the side arms of the locking unit when the second component is fully assembled. This end position of the second component relative to the flexure hinge has proven to be particularly mechanically stable and therefore advantageous. However, in principle, the plug-side end or plug-side end section of the second component can also be located in a different axial position relative to the flexure hinge when fully assembled (e.g. at the axial position where the flexure hinge is located).

In one particularly advantageous development of the invention, it can be provided that the locking unit, in particular a plug-side axial end section or a plug-side axial end of the locking unit, can bear directly against the second component when the second component is fully assembled. Preferably, the lateral surfaces of the locking unit and the second component that face one another are located in such a way as to allow this bearing.

In this way, the second component can serve as a securing means for the locking unit once it has been fully assembled. In particular, if the second component bears against the plug-side end section of the locking unit and this bearing position is located in the plug-in direction in front of the flexure hinge, a mechanically particularly robust final assembly state can be achieved, ensuring that the locking unit does not unintentionally detach even under high mechanical stress on the plug connector.

It should be emphasized at this point that it is not absolutely necessary for the second component to bear directly against the locking unit when assembled. In principle, a lateral spacing from the locking unit may also remain. Preferably, but again not necessarily, this lateral spacing can be dimensioned such that the locking unit can no longer be fully deflected and is thus at least partially blocked by the second component.

With regard to the bearing or blocking of the locking unit by the second component in its assembled state, two variants in particular can be provided:
A plug-side axial end section or a plug-side axial end of the second component bears directly against the locking unit; or
The plug-side axial end section or the plug-side axial end of the second component projects beyond the locking unit on the plug side, so that the second component bears against the locking unit with a section spaced apart from the plug-side axial end section.

It should be emphasized that the locking unit can, in principle, be secured alternatively or additionally by other means. Securing the locking unit in the assembled state can therefore also be completely independent of the second component. For example, a separate secondary securing element can be provided to redundantly secure the first component on the second component.

In one advantageous development of the invention, it can be provided that the locking means is arranged on a cable-side end section of the locking unit, for example, on a cable-side end of the locking unit.

In principle, the locking means does not necessarily have to be arranged at the cable-side end section or at the cable-side end of the locking unit. It can already be advantageous if the locking means is positioned axially closer to the cable-side end of the locking unit.

In one advantageous development of the invention, it can be provided that a lateral surface of the locking unit, in particular a lateral surface of the locking unit on a plug-side axial end section or a plug-side axial end of the locking unit, which lateral surface faces a lateral surface of a plug-side end section of the second component in the assembled state, and the locking means are formed on the same side of the locking unit.

In particular, it can be provided that the aforementioned lateral surface of the locking unit is a bearing surface for the direct bearing of the second component. The lateral surface of the locking unit can thus preferably be a contact surface of the locking unit against which the second component, or a lateral surface of the second component facing the locking unit, at least partially bears in the assembled state in order to satisfy the aforementioned securing function.

In one development of the invention, it can be provided that the locking means is formed as a locking hook, wherein the locking hook is locked in a corresponding locking recess of the second component or behind a recess of the second component in a fully assembled state of the second component.

The locking means can possibly also be formed as a locking recess or as a recess, wherein the second component can then have a corresponding locking hook or locking projection to enable the locking connection in the assembled state.

In principle, any locking means and mating locking means are suitable for locking between the two components within the scope of the present invention. However, the locking unit particularly preferably has said locking hooks.

In one advantageous configuration of the invention, it can be provided that the locking unit is in the mechanically relaxed initial state in both an unassembled state of the second component and a fully assembled state of the second component.

The elastic deflection of the locking unit into the intermediate state can thus preferably occur exclusively during the assembly of the second component. However, it should be emphasized that, depending on the application (e.g. for further improved vibration tolerance), an elastic tension or restoring force can also be provided in the locking unit after the second component has been mounted in or on the first component.

According to a further development of the invention, it can be provided that the first component is an electrically insulating component, in particular an electrically insulating plug connector housing or an insulating element (for example, an insulator element arranged between an outer conductor contact element and an inner conductor contact element, which is sometimes also referred to as a “contact element carrier”).

The second component may optionally be an electrically insulating component. Preferably, however, the second component is an electrically conductive component, in particular an electrical contact element (e.g. an outer conductor contact element or an inner conductor contact element).

Alternatively, the second component may be an electrically insulating component (e.g. an electrically insulating plug connector housing or an insulator element) and the first component an electrically conductive component (for example, an outer conductor contact element or an inner conductor contact element).

Advantageously, a robust mechanical contact or fastening between an electrically insulating component and an electrically conductive component, or between two electrically insulating components can therefore be provided in the scope of the invention. The invention thus relates to a purely mechanical contact between two plug connector components. Within the scope of the invention, it is fundamentally irrelevant which specific components are specifically involved and which component has the locking unit, which allows for particularly flexible application of the principle according to the invention.

In one development of the invention, it can be provided that the plug connector additionally has a fastening means separate from the locking unit for fastening, in particular locking, the plug connector with a corresponding mating plug connector.

Corresponding fastening means for securing the connection between plug connector and mating plug connector are generally known and are particularly advantageous in the case of plug connectors with high mechanical requirements, for which the invention claimed here can also be applied.

It should be mentioned at this point that the plug connector can also include any other plug connector components and components, such as, for example, seals, support sleeves, etc. As already mentioned above, the specific design of the plug connector and its technical features are not necessarily essential within the scope of the invention.

The invention also relates to a method for assembling an electrical or optical plug connector, having at least the following method steps:
Providing a first component which has a locking unit with a locking means;
Providing a second component;
Fastening the second component directly to the first component (in particular at least partially within the first component or at least partially on the first component), wherein the locking unit of the first component is temporarily elastically deflected from a mechanically relaxed initial state to an intermediate state via a torsionable flexure hinge formed by two opposing side arms extending at an angle to a longitudinal axis of the locking unit; and
Locking the locking means of the locking unit of the first component with the second component for mutual fastening of the two components.

The deflection of the locking unit during the assembly of the second component preferably occurs automatically through direct mechanical contact between the second component and the locking unit, in particular through mechanical contact between a plug-side end section of the second component that leads in the assembly direction or a diameter step or shell-side projection of the second component that is set back from the plug-side end section of the second component with a contact surface of the locking unit.

When the two components are assembled, it can be provided that the locking unit rests on or within the second component, thus preventing unintentional actuation after the second component is fully assembled. In this way, a self-locking primary hook can be provided for a contact element.

Features described in connection with one of the subject matters of the invention, in particular those given by the plug connector according to the invention and the method according to the invention for assembling the plug connector, can also be advantageously implemented for the other subject matters of the invention. Likewise, advantages mentioned in connection with one of the subject matters of the invention can also be understood to relate to the other subject matters of the invention.

It should also be noted that terms such as “comprising”, “having” or “with” do not exclude any other features or steps. Furthermore, terms such as “a” or “the” which indicate a singular number of steps or features do not exclude a plurality of features or steps—and vice versa.

In a purist embodiment of the invention, however, it may also be provided that the features introduced in the invention with the terms “comprising”, “having” or “with” are exhaustively listed. Accordingly, one or more lists of features within the scope of the invention may be considered complete, for example, for each claim. The invention may, for example, consist exclusively of the features mentioned in claim 1.

It should be noted that designations such as “first” or “second” etc. are primarily used for the purpose of distinguishing between the respective device or method features and are not necessarily intended to indicate that features are mutually dependent or related to each other.

Furthermore, it should be emphasized that the values and parameters described in the present case include deviations or fluctuations of ±10% or less, preferably ±5% or less, more preferably ±1% or less, and very particularly preferably ±0.1% or less of the respective named value or parameter, provided that such deviations are not excluded in the practical implementation of the invention. The specification of ranges by initial and final values also includes all those values and fractions that are encompassed by the respective named range, in particular the initial and final values and a respective mean value.

### BRIEF DESCRIPTION OF THE FIGURES

Exemplary embodiments of the invention are described in greater detail below on the basis of the drawings.

The figures each show preferred exemplary embodiments in which individual features of the present invention are represented in combination with one another. Features of an exemplary embodiment can also be implemented independently of the other features of the same exemplary embodiment and can therefore be readily combined by a person skilled in the art to form further meaningful combinations and sub-combinations with features of other exemplary embodiments.

In the figures, functionally identical elements are provided with the same reference signs.

Schematically, in the figures:

FIG. 1 shows a perspective representation of an electrical plug connector according to a first exemplary embodiment of the invention, with a first component formed as an electrically insulating plug connector housing, and a second component formed as an outer conductor contact element;

FIG. 2 shows a perspective schematic representation of a locking unit formed as a snap-fit rocker of an electrical plug connector according to the invention;

FIG. 3 shows the electrical connector according to FIG. 1 in a first assembly state of the outer conductor contact element within the plug connector housing, in which the locking unit is still in its mechanically relaxed basic state, in a lateral sectional representation;

FIG. 4 shows the electrical connector according to FIG. 3 in a second assembly state in which the locking unit was deflected into an elastic intermediate state by the leading end section of the outer conductor contact element;

FIG. 5 shows the electrical connector according to FIG. 3 in a third assembly state in which the leading end section of the outer conductor contact element passes the flexure hinge;

FIG. 6 shows the electrical plug connector according to FIG. 3 in a fourth assembly state, in which the leading end section of the outer conductor contact element has already passed the flexure hinge, shortly before the fully assembled state;

FIG. 7 shows the electrical plug connector according to FIG. 3 in a fully assembled state;

FIG. 8 shows an electrical plug connector according to a second exemplary embodiment of the invention, with a first component formed as an insulator element and a second component formed as an inner conductor contact element, assembled within the insulator element, in a perspective representation; and

FIG. 9 shows the electrical plug connector according to FIG. 8 in a lateral sectional representation.

### DETAILED DESCRIPTION OF THE ENABLING EMBODIMENTS

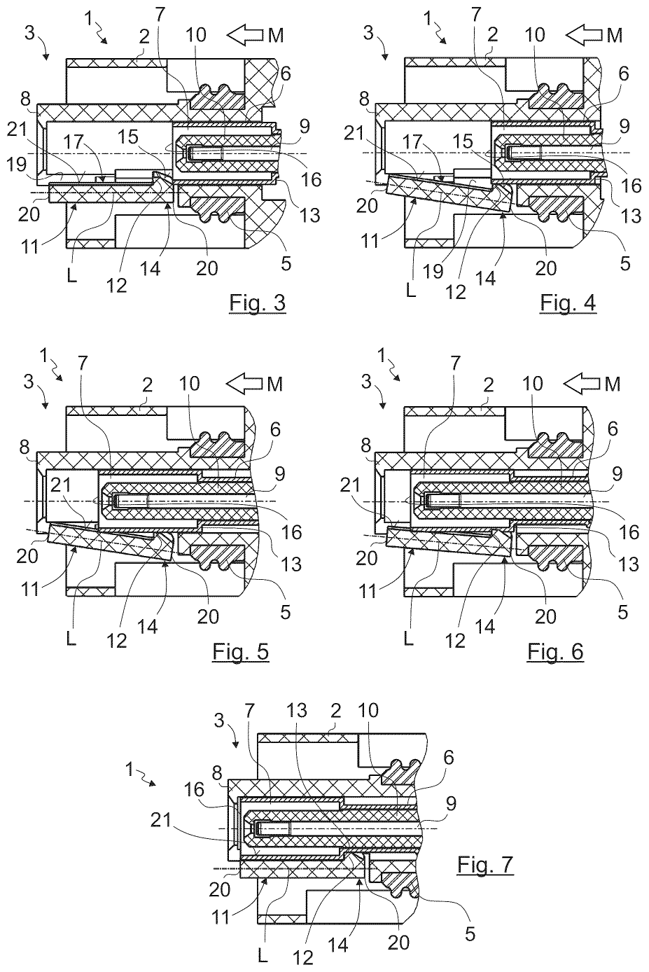

FIGS. 1 and 3 to 7 show an electrical plug connector 1 according to a first exemplary embodiment of the invention in various representations. FIG. 1 shows a perspective overall representation, while FIGS. 3 to 7 show different assembly states of the plug connector 1 in a lateral sectional representation.

In the exemplary embodiments, the plug connector 1 is represented as an electrical plug connector 1 (more precisely: as a coaxial right-angle electrical plug connector). However, the invention is also fundamentally suitable for optical plug connectors, and in particular, the geometric and functional design of the electrical plug connector 1 shown in the exemplary embodiments is to be understood merely by way of example in order to illustrate the invention.

The electrical plug connector 1 has a first component, which in the first exemplary embodiment is formed as an electrically insulating plug connector housing 2. The plug connector 1 has a plug-side end 3, which forms the interface for connection with a corresponding mating plug connector, not represented. At the plug-side end 3, the plug connector 1 may optionally have-not designated in greater detail-mechanical coding means to enable mating only with a designated mating plug connector and only in a designated orientation. Furthermore, the plug connector may have one or more fastening means 4 for locking the plug connector 1 to the mating plug connector. Sealing elements 5 may also be provided to seal areas of the plug connector 1 against the ingress of dirt and liquids. As already mentioned, the specific design of the plug connector 1 and, in particular, the plug connector housing 2, is not essential within the scope of the invention.

The plug connector 1 has a second component, which in the first embodiment is an outer conductor contact element 6 enclosed within the first component or the plug connector housing 2. For contact with a corresponding mating contact element of the mating plug connector, the outer conductor contact element 6 can, for example, have a spring cage 7 or one or more individual contact spring tabs at its plug-side end.

Optionally, the plug connector housing 2 can have a so-called Koshiri guard 8 to protect the plug-side end of the outer conductor contact element 6 from an improper plugging process. In the exemplary embodiment, the Koshiri guard 8 is formed as an annular circumferential, end-face covering of the outer conductor contact element 6.

The electrical connector 1 also has an insulator element 10 arranged between the outer conductor contact element 6 and an inner conductor contact element 9.

At the plug-side end 3 of the plug connector 1, the plug connector housing 2 has a sleeve-shaped section.

To illustrate the invention and several further components of the plug connector 1, a method according to the invention for assembling the plug connector 1 will now be described on the basis of FIGS. 3 to 7.

During the assembly of the plug connector 1, it is provided that the second component, in the present case therefore the outer conductor contact element 6, is locked on the first component, in the present case therefore the plug connector housing 2. FIGS. 3 to 6 show in this regard intermediate stages of the assembly, and FIG. 7 shows the fully assembled state of the outer conductor contact element 6 in the plug connector housing 2. In the exemplary embodiment, the outer conductor contact element 6 is assembled together with the other components pre-assembled within the outer conductor contact element 6 (in the present case, the insulator element 10 and the inner conductor contact element 9).

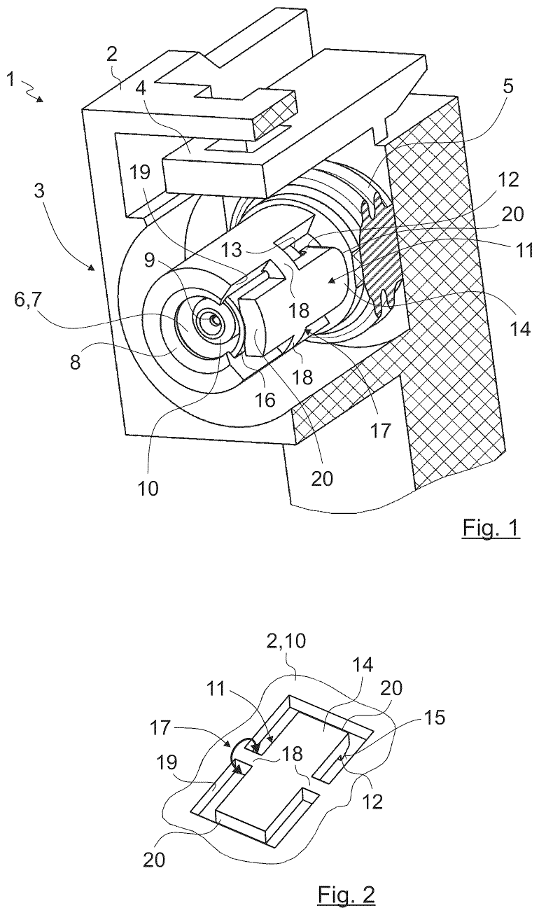

The first component or the plug connector housing 2 has a locking unit 11 which, starting from a mechanically relaxed initial state (cf. FIGS. 1 to 3 and 7), can be deflected elastically into an intermediate state (cf. FIGS. 4 to 6). In the exemplary embodiments, the locking unit 11 is realized in the manner of a snap-fit rocker and is also shown in an enlarged schematic diagram in FIG. 2 for better illustration.

For the mutual fastening of the plug connector housing 2 and the outer conductor contact element 6, the locking unit 11 has a locking means 12, which in the exemplary embodiments is formed as a locking hook 12 that, in the fully assembled state of the outer conductor contact element 6, is locked behind a corresponding recess 13 of the outer conductor contact element 6 (cf. FIG. 7). In principle, other variants and combinations of locking elements and mating locking means are also possible.

In the exemplary embodiments, the locking hook 12 is arranged on a cable-side end section 14 of the locking unit 11 and has a contact surface 15 or a chamfer inclined towards the cable-side end. This chamfer allows the locking unit 11 to be directly mechanically contacted by a plug-side end section 16 of the outer conductor contact element 6 or the second component, which is leading in a mounting direction M (cf. FIG. 3), during the assembly of the outer conductor contact element 6. The locking unit 11 can then be deflected from its initial state to the intermediate state. The automatic deflection of the locking unit 11 by inserting the outer conductor contact element 6 into the plug connector housing 2 is clearly visible on the basis of a combined view of FIGS. 3 and 4. Therefore, the locking unit 11 does not need to be actuated separately by a fitter and can optionally be inaccessible or protected from outside the plug connector 1.

As can be seen from a combined view of FIGS. 3 and 7, the locking unit 11 is in the mechanically relaxed initial state before and after the assembly of the outer conductor contact element 6, which may be advantageous for the service life of the plug connector 1.

For elastic deflection into the intermediate state, the locking unit 11 has a torsionable flexure hinge 17, which is formed by two opposing side arms 18 extending at an angle (in the exemplary embodiment orthogonally) to the longitudinal axis direction or longitudinal axis L (cf., among others, FIG. 3) of the locking unit 11 or the mounting direction M. The opposing side arms 18 can be particularly easily seen in FIGS. 1 and 2.

As can also be clearly seen on the basis of FIGS. 1 and 2, the first component, or plug connector housing 2, has a recess 19 in its sleeve-shaped section in which the locking unit 11 is movably arranged (tiltable in the direction of the outer conductor contact element 6 or the second component). The locking unit 11 is fastened to the surrounding residual body of the plug connector housing 2 by means of the aforementioned side arms 18, which are arranged at the same axial position on opposite sides of the locking unit 11, and is thus pivotably held in the recess 19. A deflection of the locking unit 11 by the insertion of the outer conductor contact element 6 therefore leads to a torsion of the side arms 18. It is particularly advantageous if the flexure hinge 17 or if the side arms 18 of the locking unit 11 are located in an axial central section along the longitudinal axis L of the locking unit 11, as represented in the exemplary embodiments. In this way, the locking unit 11 has two opposing, freely movable axial ends 20 along the longitudinal axis direction.

The proposed torsionable flexure hinge 17 allows for precise control of the assembly force required to insert the second component or the outer conductor contact element 6, even when the installation space within the plug connector 1 is limited (for example, due to a sealing element 5). This enables material-friendly and damage-free assembly, as, for example, abrasion or chip formation on the locking hook 12 can be prevented. Only when the leading end section of the outer conductor contact element 6 has passed the flexure hinge 17 (cf. FIGS. 5 and 6) does the locking unit 11 need to deform slightly to allow further insertion of the second component or the outer conductor contact element 6, which can increase the force required for final assembly. However, due to the shallow angle, chip formation or damage to the components can still be advantageously prevented.

In a fully assembled state of the outer conductor contact element 6 (cf. FIG. 7), the plug-side end of the outer conductor contact element 6 is arranged closer to the plug-side end 3 of the plug connector 1 than the flexure hinge 17 of the locking unit 11. In this state, the lateral surface of the plug-side end section of the outer conductor contact element 6 also bears directly against the lateral surface 21 of the locking unit 11 facing it (alternatively, a different section of the outer conductor contact element 6, positioned further back on the cable side, can also bear against the lateral surface 21 of the locking unit 11 if the plug-side end section of the outer conductor contact element 6 extends beyond the locking unit 11 on the plug-side). In this way, the outer conductor contact element 6, or the second component itself, can serve as a securing means to ensure that the locking unit 11 is not unintentionally actuated and the locking mechanism between the two components is not released. The lateral surface 21 of the locking unit 11 for direct bearing against the lateral surface of the second component or the external conductor contact element 6 and the locking means 12 are therefore advantageously arranged on the same side of the locking unit 11.

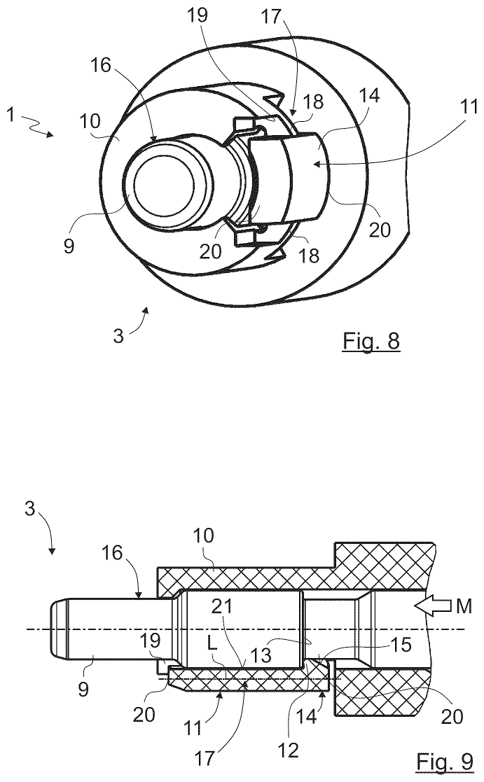

As already mentioned above, the components to be fastened to one another or locked together can also be other components of the plug connector 1. By way of example, FIGS. 8 and 9 are intended to show yet another exemplary embodiment of the invention, in which the “first component” is an insulator element 10 arranged between the outer conductor contact element 6 and the inner conductor contact element 9, and the “second component” is the inner conductor contact element 9. Apart from this, the second exemplary embodiment of FIGS. 8 and 9 essentially corresponds to the first exemplary embodiment already described, which is why further details will not be discussed here.

It should also be mentioned at this point that a combination of the two exemplary embodiments shown is also possible in principle, wherein, for example, on one hand, the presented locking mechanism can be provided between plug connector housing 2 and outer conductor contact element 6 and also between insulator element 10 and inner conductor contact element 9.

Furthermore, a locking mechanism between the outer conductor contact element 6 and the insulator element 10 can also be provided according to the presented principle according to the invention. Finally, it should be emphasized that the “second component” can also be assembled, at least partially, on the first component (i.e. complementary to the arrangement already presented). Even a locking mechanism between two adjacent, electrically insulating components can be provided within the scope of the invention.

1. A plug connector, in particular electrical plug connector, having a first component and a second component directly fastened to the first component, wherein the first component has a locking unit that can be temporarily deflected elastically from a mechanically relaxed initial state to an intermediate state via a flexure hinge, wherein the locking unit has a locking means that can be locked to the second component for mutual fastening of the two components, and wherein the flexure hinge is torsionable and is formed by two opposing side arms extending at an angle to a longitudinal axis of the locking unit.

2. The plug connector as claimed in claim 1, wherein the second component is at least partially received within the first component or the first component is at least partially received within the second component.

3. The plug connector as claimed in claim 1, wherein the side arms extend orthogonally to the longitudinal axis of the locking unit, wherein the side arms are preferably arranged at the same axial position on opposite sides of the locking unit.

4. The plug connector as claimed in claim 1, wherein a residual body of the first component has a recess in which the locking unit is movably arranged, in particular tiltable in the direction of the second component, wherein the locking unit is connected to the residual body of the first component via the side arms and is fastened within the recess.

5. The plug connector as claimed in claim 1, wherein the locking unit has two opposing, freely movable axial ends along the longitudinal axis, and wherein the side arms of the locking unit are formed in an axial central section along the longitudinal axis, preferably centrally between the axial ends of the locking unit.

6. The plug connector as claimed in claim 1, wherein the locking unit is inaccessible from outside the plug connector, in particular inaccessible for mechanical actuation by a fitter.

7. The plug connector as claimed in claim 1, wherein the second component can be assembled in the direction of a plug-side end of the plug connector, wherein the locking unit can be directly mechanically contacted by the second component during the assembly of the second component and can be deflected from the initial state to the intermediate state.

8. The plug connector as claimed in claim 1, wherein the side arms of the locking unit are located in an axial position between a plug-side end section and a cable-side end section of the second component facing away from the plug-side end section in a fully assembled state of the second component.

9. The plug connector as claimed in claim 8, wherein a plug-side axial end section of the locking unit in the fully assembled state of the second component bears directly against the second component.

10. The plug connector as claimed in claim 1, wherein the locking means is arranged on a cable-side end section of the locking unit.

11. The plug connector as claimed in claim 1, wherein a lateral surface of the locking unit which faces a lateral surface of a plug-side end section of the second component in the assembled state, and the locking means are formed on the same side of the locking unit.

12. The plug connector as claimed in claim 1, wherein the locking means is formed as a locking hook, wherein the locking hook is locked in a corresponding locking recess of the second component or behind a recess of the second component in a fully assembled state of the second component.

13. The plug connector as claimed in claim 1, wherein the first component is an electrically insulating component, in particular an electrically insulating plug connector housing or an insulating element, and wherein the second component is an electrically conductive component, in particular an outer conductor contact element or an inner conductor contact element.

14. A method for assembling a plug connector, having at least the following method steps:
Providing a first component which has a locking unit with a locking means;
Providing a second component;
Fastening the second component directly to the first component, wherein the locking unit of the first component is temporarily elastically deflected from a mechanically relaxed initial state to an intermediate state via a torsionable flexure hinge formed by two opposing side arms extending at an angle to a longitudinal axis of the locking unit; and
Locking the locking means of the locking unit of the first component with the second component for mutual fastening of the two components.
